(19) United States
(12) Patent Application Publication
(10) Pub. No.: US 2010/0168297 A1
(43) Pub. Date: Jul. 1, 2010

(54) HIGH-GLOSS POLYURETHANE COATINGS PREPARED FROM ALLOPHANATE/POLYISOCYANATE HARDENER COMPOSITIONS

(76) Inventor: Damien Bourgeois, Clapiers (FR)

Correspondence Address: BUCHANAN, INGERSOLL & ROONEY PC, POST OFFICE BOX 1404, ALEXANDRIA, VA, 22313-1404, US

(21) Appl. No.: 12/442,263

(22) PCT Filed: Sep. 21, 2007
(86) PCT No.: PCT/FR2007/001543

§ 371 Date: Aug. 31, 2009

(30) Foreign Application Priority Data
Sep. 22, 2006 (FR) 0608341

(51) Int. Cl. C08K 5/52; C08L 75/04; C08K 5/10; C08K 5/13

(52) U.S. Cl. 524/140; 524/589; 524/317; 524/334

(57) ABSTRACT

Hydrophilic hardener compositions include at least one hydrophobic polyisocyanate, the hydrophobic polyisocyanate containing one or more allophanate functional groups, and the allophanate functional groups being present in the hardener compositions in an amount at least equal to 6 mol % relative to the total number of moles of isocyanate monomers converted in the preparation of the hardener composition, and are useful for the preparation in aqueous phase of high-gloss polyurethane coating formulations.

The present invention relates to the use of polyisocyanate compositions for producing coatings, in particular paints or varnishes, which have increased shine and are suitable for any type of support, in particular wood.

The fields of application in which coatings are used are widely varied and increasingly require technologically advanced compositions having excellent qualities with regard to both the plane of application of the coating and the characteristics of the finished product.

There is constant demand for coatings with improved properties, such as increased drying speed, increased hardness, a decrease in the amounts of solvents or even the complete absence of solvents, etc., to name only those which are most often sought.

There is, for example, a strong demand for coating compositions, paints or varnishes for any type of support, in particular wood, plastics material, glass, metal, masonry elements for walls and flooring which have excellent properties with regard to shine, in particular for polyurethane-type coating compositions in aqueous phase.

Polyurethane-type coating compositions in aqueous phase are already known, in which the hardener basically comprises a hydrophobic isocyanate component to which a surfactant is added or even grafted in such a way that a hydrophilic hardener with an isocyanate component is obtained.

However, it has been found that hardeners of this type often lead to a decrease in or even a complete loss of the shine of the final coating composition, although said composition does exhibit improved mechanical properties (hardness and resistance to abrasion for example). It is thus desirable to be able to produce hardeners for polyurethane-type coatings, which hardeners provide said coatings with good mechanical properties as well as increased shine, especially for flooring coatings, and in particular for wood coatings.

Therefore, a first object of the present invention is to provide a coating composition having improved properties in terms of shine in relation to coating compositions which are known in the field.

Another object of the invention is to provide a polyurethane-type aqueous coating composition having improved properties in terms of shine in relation to coating compositions which are known in the field.

Another object of the present invention is to provide an aqueous coating composition having improved properties in terms of shine as a polyurethane-type coating, paint or varnish, in particular a flooring coating, especially for wood.

Other objects will emerge from the following description of the invention.

The present invention thus firstly relates to the use of a hydrophilic polyisocyanate-type hardener composition comprising at least one hydrophobic polyisocyanate, said hydrophobic polyisocyanate comprising one or more allophanate functions, said allophanate functions being present in said hardener composition in an amount at least equal to 6 mol % relative to the total number of moles of isocyanate monomers converted when preparing the hardener composition, for preparing a polyurethane coating formulation in aqueous phase.

The coating composition defined above optionally further comprises one or more pigments and/or additives which facilitate the use of the formulation or the production of coatings. Said additives are selected, in particular, from rheological additives, levelling additives, surfactant additives and other additives, and mixtures thereof.

The coating obtained by using the composition defined above has a good appearance and good mechanical properties as well as increased shine, more specifically increased shine in relation to coatings of the prior art.

The present invention further allows a very good balance to be achieved between low viscosity of the hardener and shine of the coating, as illustrated hereinafter.

The use constituting one of the objects of the present invention is particularly suitable for the field of varnishes for flooring coatings, in particular for a wood support.

As well as a high level of shine, increased hardness, good adherence to the substrate and good resistance to chemical and ultraviolet attacks, among other properties, are seeked for coatings, especially of the varnish type, in particular for flooring coatings.

Surprisingly, it is now been found that the presence of allophanate functions in the hydrophobic polyisocyanates present in a hydrophilic polyisocyanate composition forming the hardener of polyurethane compositions makes it possible to significantly improve these properties.

In the scope of the present invention, the claimed use allows a coating to be prepared in the form of a monocomponent formulation (1K) or a biocomponent formulation (2K) or even a multicomponent formulation, the 2K formulations being particularly preferred. Each of these formulations may be in aqueous or hydro-organic form (water+solvent).

Within the meaning of the present invention, “hydrophilic polyisocyanate” means a polyisocyanate which is self-emulsionable in water, that is to say it forms, upon contact with any composition in aqueous phase, a stable emulsion of organic isocyanate particles in the aqueous medium, said aqueous medium being a solution, dispersion or emulsion. “Hydrophobic polyisocyanate” means a polyisocyanate which does not correspond to the definition given above.

The hydrophilic polyisocyanate (or the hydrophilic polyisocyanate composition) may be hydrophilic by nature or even mixed with and/or grafted with one or more surfactants able to render said polyisocyanate hydrophilic. For the purposes of the invention, one or more ionic or non-ionic surfactants are preferably added to a hydrophobic polyisocyanate, and/or one or more ionic or non-ionic surfactants are grafted onto a hydrophobic polyisocyanate.

It is particularly advantageous to use, as a surfactant, an anionic surfactant or even a non-ionic surfactant optionally comprising a polyethylene glycol and/or propylene glycol chain fragment having at least 1, advantageously at least 3, preferably at least 5 ethylene oxyl and/or propylene oxyl units.

Hydrophilic polyisocyanates of this type are known in particular and non-limiting examples are Bayhydur® XP 2487 or Bayhydur® 3100 sold by Bayer, or even Rhodocoat® X EZ-M 502 or Rhodocoat® X EZ-M 501 sold by Rhodia.

The surfactant is advantageously selected in such a way that it does not comprise any functions, or comprises only a small amount of functions, which are reactive with the polyisocyanate. In other words, the surfactant is present in the polyisocyanate composition in a substantially free form (in contrast with a form in which it is bound by a chemical bond to the polyisocyanates).

The term “substantially free form” means that less than 50%, advantageously less than 20%, preferably less than 10% by weight of the surfactant is in a bound form.

However, the compositions in which the surfactant is mostly, or even completely, bound in a covalent manner to the polyisocyanates by a carbamate or urea function are also included within the scope of the present invention.

According to a preferred embodiment, the surfactant is an anionic agent with at least one function selected from aryl and/or alkyl sulphates or phosphates, and aryl or alkyl phosphonates, phosphinates and sulphonates.

Even more preferably, the anionic surfactant comprises a hydrophilic portion formed, for example, from said anionic function of said polyethylene glycol and/or polypropylene glycol chain fragment and from a hydrocarbon radical-based lipophilic portion. The lipophilic portion is preferably selected from alkyl and aryl groups, preferably C₆-C₃₀ alkyl and aryl groups.

It is of course to be understood that the composition of the present invention which is in the form of a solution may comprise a mixture of at least two surfactants, as disclosed in the present description.

An anionic surfactant corresponding to the following formula (I) is particularly preferred:

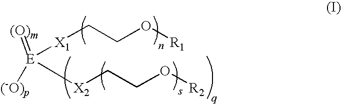

in which:
E represents an element selected from phosphorus, carbon and sulphur;
R₁ and R₂ are the same or different and represent, independently of one another, a hydrocarbon radical, advantageously selected from C₆-C₃₀ aryl radicals and C₁-C₂₀ alkyl radicals, optionally substituted, advantageously C₁₀-C₂₀ alkyl radicals, optionally substituted.
X₁ represents a bond or a divalent radical selected from —Y₁—, -A₁-, -A₁-Y₁—, —Y₁-A₁-, —Y₁-A₁-Y′₁— and —[E(O)ₘ(O⁻)ₚ]—;
X₂ represents a bond or a divalent radical selected from —Y₂—, -A₂-, -A₂-Y₂—, —Y₂-A₂- and —Y₂-A₂-Y′₂—;
A₁ and A₂ are the same or different and represent, independently of one another, a divalent alkylene radical, optionally substituted, including a functionalised divalent alkylene radical and, for example, ethylene or methylene;
Y₁, Y′₁, Y₂ and Y′₂ are the same or different and are selected from a chalcogen, advantageously selected from the lightest chalcogens, that is to say sulphur and, in particular, oxygen, the metalloid elements having atomic sizes at least equal to that of phosphorus and belonging to column VB of the periodic table in the form of tertiary amine or phosphine derivatives, the radical which provides the tertiary character advantageously having at most 4 carbon atoms, preferably at most two carbon atoms;
m represents zero or an integer equal to 1 or 2;
n is zero or an integer selected between 1 and 30, advantageously between 5 and 25, preferably between 9 and 20 (inclusive, that is to say including the boundary values);
p represents an integer equal to 1, 2 or 3;
q represents zero or 1; and
s represents zero or an integer between 1 and 30, advantageously 5 and 25, preferably between 9 and 20 (inclusive, that is to say including the boundary values);
   it being understood that when E represents a carbon atom, then q is equal to zero, m represents 1 and X₁ represents a bond or a divalent radical selected from -A₁-, —Y₁—, -A₁-Y₁—, —O—C(═O)—O— and —[C(O)ₘ(O⁻)ₚ]—.

Although this does not form part of the preferred compounds, it should be noted that s and/or n may be equal to zero when E is phosphorus and that, when s and n are equal to zero, R₁ and/or R₂ respectively represent (advantageously branched) C₈-C₁₂ alkyls, or C₁₂-C₁₆ aralkyls or C₁₀-C₁₄ alkyl aryls.

When E represents a phosphorus atom and X₁ represents a —[E(O)ₘ(O⁻)ₚ]— radical, the compound of formula (I) belongs to the family of pyro acids, such as the symmetrical or asymmetrical diesters of pyrophosphoric acid.

The total carbon number in the surfactants of formula (I) intended by the present invention is advantageously at most 100, preferably at most 60, advantageously at most 50.

The divalent radical X₁, and optionally the divalent radical X₂, may advantageously be selected from the following divalent radicals (the left-hand side of the formula being bound to E):
when E represents a phosphorus atom, one of X₁ or X₂ may be selected from —O—P(═O)(O⁻)—X″— and —O—(R₁₀—O)P(═O)—X″, R₁₀ representing a C₂ to C₃₀ hydrocarbon residue comprising one or more ethylene oxyl or propylene oxyl units, advantageously at least 5, preferably at least 7 ethylene oxyl or propylene oxyl units and X″ representing an oxygen atom or a simple bond;
a direct bond between E and the first divalent ethylene radical of said polyethylene glycol (or polypropylene glycol) chain fragment;
a divalent methylene radical, optionally substituted, and in this case advantageously partly functionalised;
a divalent radical selected from —Y₁—, -A₁-Y₁—, —Y₁-A₁-Y′₁— and —[E(O)ₘ(O⁻)ₚ]—, in the case of X₁, and selected from —Y₂—, -A₂-, -A₂-Y₂—, —Y₂-A₂- and —Y₂-A₂-Y′₂ in the case of X₂, where —Y₁, Y′₁, Y₂ and Y′₂— are as defined above and A₁ and A₂ are the same or different and represent, independently of one another, an alkylene radical, optionally substituted, including a functionalised alkylene radical, A₁ and A₂ advantageously being ethylene or methylene, preferably ethylene in -A₁-Y₁— (or -A₂-Y₂—) structures and above all in —Y₁-A₁-Y′₁— or (—Y₂-A₂-Y′₂—) structures, and methylene in -A₁-Y₁— (or -A₂-Y₂—) structures.

When E represent a phosphorus atom, formula (I) becomes formula (II):

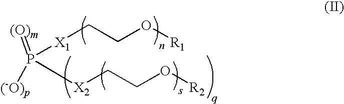

which, when q is zero, becomes formula (II′):

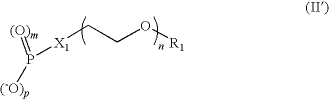

in which formulae (II) and (II′) R₁, R₂, X₁, X₂, in, n, p, q, and s are as defined above.

When E represents a carbon atom, formula (I) becomes formula (III):

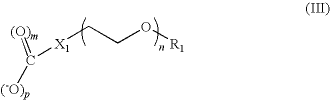

in which R₁, m, n and p are as defined above and X₁ represents a bond or a divalent radical selected from -A₁-, -A₁-Y₁—, and —[C(O)ₘ(O⁻)ₚ]—, where A₁ and Y₁ are as defined above.

Among the surfactants which may be used in the present invention, those of formula (II) above are particularly preferred, in neutralised or unneutralised form and being of structure (II₁) or structure (II₂) as follows:

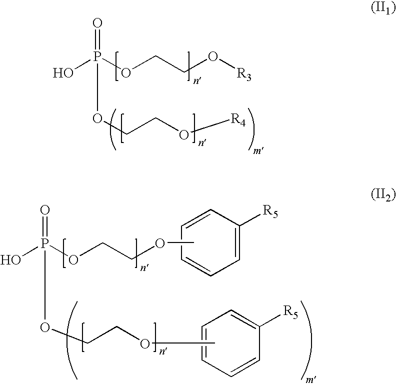

in which structures:
n′ represents an integer between 5 and 12, inclusive;
m′ represents 0 or 1;
R₃ and R₄ are the same or different and represent, independently of one another, a linear or branched alkyl radical containing from 10 to 20 carbon atoms; and
R₅ represents a linear or branched alkyl radical containing from 6 to 12 carbon atoms.

Compounds of structure (II₁) where R₃ and R₄ each represent an alkyl radical containing 13 carbon atoms, for example the radical n-C₁₃H₂₇, are particularly preferred.

Compounds of structure (II₂) where R₅ represents an alkyl radical containing 9 carbon atoms, for example the radical n-C₁₉H₁₉, are also preferred.

In the formulae above, the ethylene oxyl groups may be replaced in part with propylene oxyl groups. However, it is desirable in this case for the compounds to comprise, for the most part, ethylene oxyl groups.

Surfactants which are particularly advantageous for use according to the present invention are selected, for example, from Rhodafac® RE 610, RS 610, RS 610 LN, RS 710, SS 610 and mixtures of two or more thereof at any ratio.

The periodic table used in the present application is that provided in the Bulletin de la SociétéChimique de France, January 1966, No. 1.

The alkylenes and, in particular, methylenes (X₁, X′₁, X₂ and X′₂) are optionally functionalised by hydrophilic functions (tertiary amines and other anionic functions including those described above in the form —[E(O)ₘ(O⁻)ₚ]—).

The counter cation is advantageously monovalent and is selected from quaternary or tertiary mineral and organic cations, advantageously non-nucleophilic cations, in particular the “oniums” in column V of the periodic table, such as phosphonium and ammonium, or from column VI of said table, such as sulphonium and other oniums, and mixtures thereof.

Ammonium-type counter cations obtained from an advantageously tertiary amine are preferred. Furthermore, it is preferable for the organic cation not to comprise a hydrogen which is reactive with the isocyanate function.

These tertiary amines may optionally have properties of ultraviolet (UV) ray protection, such as the amines known by the name “Hals amines”, for example N,2,2,6,6,-penta-methylpiperidine.

Mineral cations may be confined by phase transfer agents, such as crown ethers.

The pKa of organic or mineral cations is advantageously between 8 and 12.

Tertiary amines having at most 12 carbon atoms, advantageously at most 10 carbon atoms, preferably at most 8 carbon atoms per “onium” function (bearing in mind that there is preferably only one per molecule) are preferred. In particular, examples are N,N-dimethyl cyclohexyl amine and tributyl amine.

The amines may or may not comprise other functions, in particular functions corresponding to amino acid functions and cyclic ether functions, such as N-methyl morpholine. These other functions are advantageously in a form which does not react with the isocyanate functions.

If the composition according to the invention comprises the surfactant in anionic form, said surfactant is likely to react with the isocyanate functions. It may thus be advantageous to use the anionic surfactant according to the present invention in a neutralised form in such a way that the pH obtained after dissolution or contact with water is at least equal to 3, advantageously 4, preferably 5 and at most equal to 12, advantageously 11, preferably 10.

When E represents phosphorus, it is desirable to use mixtures of monoester and diester at a molar ratio between 1/10 and 10, advantageously between 1/4 and 4. Mixtures of this type may also comprise from 1% to approximately 20%, but preferably no more than 10% by weight of phosphoric acid, and from 0 to 5% of pyrophosphoric acid esters. The phosphoric acid is advantageously salified, at least in part, so as to lie within the aforementioned pH ranges.

In the case of the mono- and diesters, some of the ethylene oxyl groups may be replaced with propylene oxyl groups. However, it is preferable for the ethylene oxyl groups to be present in a majority.

It is possible for triester compounds to be present on condition that these compounds are not too light. In general, at least one of the three ester functions must have a carbon number greater than 5, preferably greater than 6, or at least two of the three ester functions must have a carbon number greater than 2.

The surfactants of formula (I) defined above may be kept in their acid form (the O⁻ charge thus being replaced with the OH group) if they are introduced into the polyisocyanate formulation after the reaction in which the isocyanate functions are masked.

According to another embodiment, the surfactant is a non-ionic surfactant.

Generally, if a non-ionic surfactant is used it has a sufficient amount of hydrophilic groups, such as ethylene oxyl groups, generally more than approximately 10. This surfactant also has a hydrophobic portion which may be selected from the aromatic groups carrying aliphatic chains or simply from aliphatic chains having a carbon number between 8 and 50. Other hydrophobic patterns, such as silicone or fluorine patterns, may also be used for specific applications.

Non-limiting examples are derivatives of polyoxyalkylene fatty acid esters, ethoxylated alkylphenols, ester phosphates with a poly alkyloxy alkylene glycol chain (such as poly-ethoxy and/or -propoxy ethylene glycol), and tristyrylphenols with an ethylene polyoxide chain.

In particular, a surfactant selected from one of the condensates of poly(ethylene oxide) and/or poly(propylene oxide) with alcohols, polyols, alkylphenols, fatty acid esters, fatty acid amides and fatty amines, and sugars, in particular sugar esters, is preferred.

A mixture of (neutralised or unneutralised) anionic and/or non-ionic surfactants may also be used within the scope of the invention.

As mentioned above, the presence of a surfactant in the composition according to the invention increases the hydrophilic nature of the hydrophobic polyisocyanate(s) present in the polyisocyanate composition so as to provide a homogeneous mixture of this hardener composition with the coating formulation.

Generally, the amount of surfactant or mixture of surfactants is relatively low compared with the polyisocyanate composition. This amount is advantageously lower than 25% by weight relative to the polyisocyanate composition, preferably lower than 20% by weight and more preferably lower than 15%. It is at least equal to 1%, preferably at least equal to 2% relative to the weight of the polyisocyanate composition.

The ratio by weight between the polyisocyanate composition and said surfactant(s) is thus advantageously between 1% and 30%, preferably between 2% and 20%, for example between 3% and 12%.

The polyisocyanate composition contained in the composition according to the present invention consists in all types of isocyanate and polyisocyanate, alone or in combination with one or more other isocyanates and/or polyisocyanates. The term “polyisocyanate” is to be understood in this case as encompassing the terms “isocyanate” and “polyisocyanate”.

Preferred polyisocyanates are selected from the homocondensation or heterocondensation products of alkylene diisocyanate, comprising in particular “biuret”-type and “trimer”-type products, or. isocyanate function “prepolymers”, and from mixtures thereof.

The polyisocyanate compounds may also comprise true carbamate functions (R—O—C(═O)—NH₂) or epoxy functions or (preferably cyclic) carbonate functions.

They may, for example, be the polyisocyanates sold by Rhodia under the name “Tolonate®”.

Preferred polyisocyanates are generally the homocondensation or heterocondensation products of the following aliphatic, cycloaliphatic or arylaliphatic isocyanate monomers:
1,6-hexamethylene diisocyanate,
1,12-dodecane diisocyanate,
cyclobutane-1,3-diisocyanate,
cyclohexane-1,3 and/or 1,4-diisocyanate,
1-isocyanato-3,3,5-trimethyl-5-diisocyanatomethylcyclohexane (isophorone diisocyanate, IPDI),
isocyanatomethyloctylene diisocyanates (TTI), in particular 4-isocyanatomethyl-1,8-octylene-diisocyanate,
2,4 and/or 2,6-hexahydrotoluoylene diisocyanate (H₆TDI),
hexahydro-1,3 and/or 1,4-phenylene diisocyanate,
perhydro 2,4′ and/or 4,4′-diphenylmethane diisocyanate (H₁₂MDI), and the aromatic amino precursors or perhydrogenated carbamates in general,
bis-isocyanatomethyl cyclohexanes (1,3 and 1,4 in particular) (BIC),
bis-isocyanatomethyl norbornanes (NBDI),
2-methylpentamethylene diisocyanate (MPDI),
tetramethylxylylene diisocyanates (TXMDI), and
lysine diisocyanate and lysine di- or triisocyanate (LDI or LTI) esters.

Among the isocyanates listed above, HDI is preferred in particular.

The homocondensation products are products resulting from the condensation of one of the isocyanate monomers listed above with itself. The heterocondensation products are products resulting from the condensation of two or more of the monomers listed above with one another and/or optionally with one or more mobile hydrogen compounds, such as an alcohol, a diol, an amine and other similar compounds.

The polyisocyanates contained in the composition of the present invention may also be polyisocyanate derivatives resulting from aromatic isocyanates used alone or mixed with aliphatic compounds.

However, the use of these aromatic derivatives is limited in terms of the amount and is also not a preferred variant, since this generally results in coatings which may undergo coloration, generally yellowing, as they age, particularly if the coatings are exposed to a high degree of ultraviolet radiation, for example solar ultraviolet radiation.

Examples of non-limited aromatic isocyanates include:
2,4- and/or 2,6-toluoylene diisocyanate,
diphenylmethane-2,4′ and/or 4,4′-diisocyanate (MDI),
1,3- and/or 1,4-phenylene diisocyanate,
triphenylmethane-4,4′,4″-triisocyanate, and
MDI or TDI oligomers.

Mixtures of these (cyclo)aliphatic and/or aromatic polyisocyanates may also be used.

As mentioned above, the hydrophilic polyisocyanate-type hardener composition comprises, in accordance with the use according to the present invention, at least one hydrophobic polyisocyanate, said hydrophobic polyisocyanate comprising one or more allophanate functions, said allophanate functions being present in said hydrophilic polyisocyanate-type hardener composition in an amount at least equal to 6 mol %, advantageously at least 8 mol % relative to the total number of moles of isocyanate monomers converted when preparing the hardener composition. This amount is generally less than or equal to 30 mol %, preferably less than or equal to 25 mol %.

The compounds carrying one or more allophanate functions are obtained in accordance with conventional methods well-known to the person skilled in the art, that is to say by reacting at least one compound carrying a hydroxyl function (such as alcohol, diol, and other compounds) and at least one hydrophobic isocyanate or hydrophobic polyisocyanate, as defined above, generally in the presence of a catalyst.

By way of example, the allophanates may advantageously be prepared either directly from an isocyanate and the desired alcohol by heating in the presence of a dibutyltin dilaurate-type catalyst (as disclosed in patent application WO 99/55756), or from an isocyanate and the desired alcohol by modifying the conditions for trimerisation with quaternary ammonium hydroxides (as disclosed in patent application EP 0 524 500).

For the purposes of the present invention, the preferred compounds are those carrying one or more allophanate functions obtained from at least one polyisocyanate and at least one monoalcohol, preferably an alkyl, linear, branched or cyclic alcohol, containing from 1 to 20 carbon atoms, advantageously 1 to 16 carbon atoms, more particularly 1 to 12 carbon atoms, for example methanol, ethanol, 1-propanol, 2-propanol, butanol, pentanol, hexanol, cyclohexanol, 2-ethylhexanol, decanol and others.

The polyisocyanates used to prepare compounds carrying one or more allophanate functions are hydrophobic polyisocyanates optionally comprising one or more functions selected from diazetidinedione, oxadiazinetrione, imino-dimer, imino-trimer (imino-triazadione), imino-oxadiazinedione (also known as an asymmetrical trimer), isocyanurate, biuret, urea, urethane and mixtures thereof.

The polyisocyanates used to prepare compounds carrying an allophanate function or allophanate functions are preferably hydrophobic polyisocyanates comprising products of the cyclotrimerisation of polyisocyanates, in particular of diisocyanates.

Particularly preferred compounds are those carrying one or more allophanate functions obtained from the homocondensation and/or heterocondensation products of one or more aliphatic, in particular non-cyclic, isocyanate monomers, preferably HDI and/or HDI isocyanurate, also known as HDT.

Also preferred are compounds carrying one or more allophanate functions obtained from the homocondensation and/or heterocondensation products of one or more aliphatic, in particular non-cyclic, isocyanate monomers, preferably HDI and/or HDI isocyanurate, also known as HDT, with a linear, branched or cyclic monoalcohol as defined above.

By way of purely illustrative example, the diagram below shows hydrophobic polyisocyanates carrying an allophanate function obtained by reacting an alcohol with HDI on the one hand, and with HDT on the other hand:

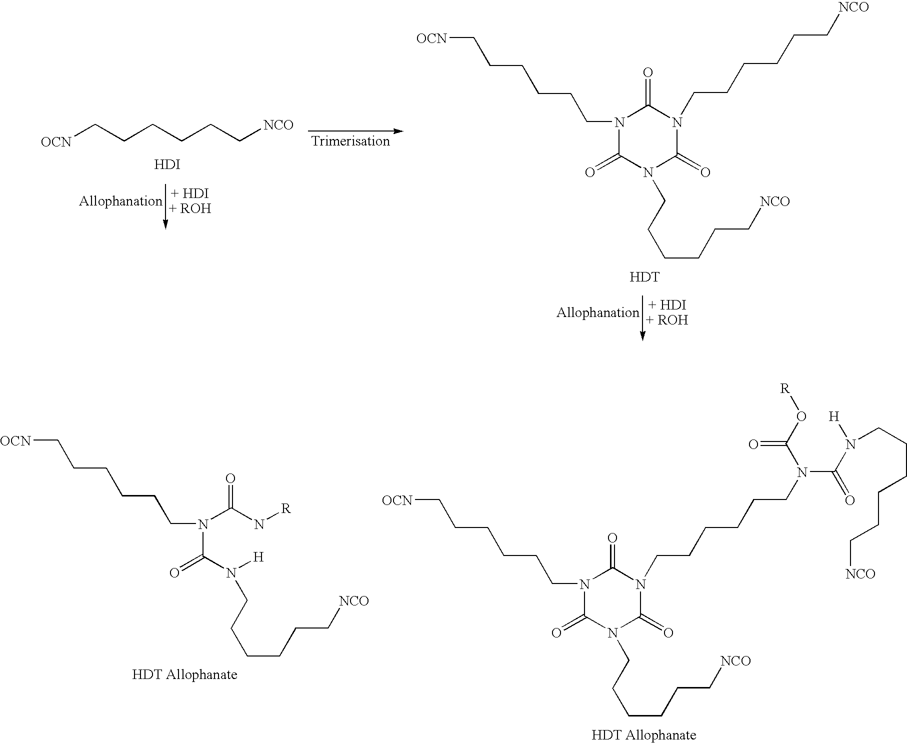

The amount of allophanate functions is measured by calculating the molar percentage of the allophanate functions relative to the number of moles of initial isocyanate converted. For example, in the diagram above, the HDT allophanate has 1 mole of allophanate function per 4 moles of converted monomer which represents an amount equal to 25 mol % of allophanate functions relative to the number of moles of converted monomer. This calculation is carried out by way of carbon NMR. For the hardener compositions which are suitable for the use according to the invention, the molar percentage also reflects the number of moles of monomers converted so as to form hydrophilic polyisocyanates.

The polyisocyanate-type hardener compositions for coatings according to the invention have an average functionality of isocyanate functions greater than 2 and at most equal to 10, preferably greater than 2.5 and at most equal to 8, advantageously between 2.8 and 6.5.

Throughout the present description, functionality is expressed in weight, as is usual in this field, said functionality being obtained by multiplying the percentage by weight of each oligomer in the composition by its own functionality, then the functionalities for each oligomer being added together. The total represents the average functionality of the composition.

In the present invention, the amount of isocyanate functions (Tx(NCO)) in a composition is also defined and is expressed as a percentage by weight. This amount is equal to the number of moles of NCO per 100 g of said composition multiplied by 42.02 (molar mass of the isocyanate function). The number of moles of NCO is determined by conventional assay methods known to the person skilled in the art, for example by potentiometric assay with dibutylamine.

The viscosity of the non-masked polyisocyanate compounds used in the invention lies within a wide viscosity range determined by the structure of the polyisocyanate compounds which may be used. The viscosity is generally greater than 10 mPa·s at 25° C. with a non-volatile matter content of 100%, more generally greater than 100 mPa·s at 25° C. and with a non-volatile matter content of 100%.

The viscosity of the polyisocyanates is generally less than 5,000 mPa·s at 25° C. and with a non-volatile matter content of 100%, even more generally less than 3,500 mPa·s at 25° C. and with a non-volatile matter content of 100%. Particularly satisfactory results have been obtained using polyisocyanates with a viscosity less than 2,000 mPa·s at 25° C. and with a non-volatile matter content of 100%.

It should be noted that the addition of compounds carrying one or more allophanate functions makes it possible to achieve a particularly satisfactory balance between viscosity and the shine of the final hardened coating.

The polyisocyanates present in the composition according to the invention may be masked, that is to say the isocyanate functions are not free but are masked by a masking agent or a mixture of masking agents. It is preferable, in particular, to use compositions containing (poly)isocyanates which are masked for the preparation of a monocomponent (1K) coating formulation.

“Masked polyisocyanate” is to be understood in the present description as a polyisocyanate for which at least 50%, preferably 80%, advantageously 90%, and more preferably all of the isocyanate functions are masked.

The hydrophilic polyisocyanates comprising hydrophobic polyisocyanates carrying allophanate functions, as defined above, are used, in the formulation in aqueous phase, as composition hardeners which will now be described for the preparation of polyurethane-type coatings.

The compositions (or simply “resins” hereinafter in the present description) which are suitable for the preparation of a polyisocyanate coating formulation in aqueous phase with the hardeners defined above may be polyurethane compositions and/or compositions comprising compounds able to react with the isocyanate functions of the hardeners so as to form polyurethane groups.

Preferred polyurethane compositions are those in dispersion, optionally comprising mobile hydrogen functions. Non-limiting examples are polyurethane resins and polyether-polyurethane aqueous dispersions, such as the resin U 205 sold by Alberdingk & Boley.

The compounds able to react with the isocyanate functions of the hardeners are those compounds known to the person skilled in the art and preferably having at least two mobile hydrogen atoms, up to approximately twenty mobile hydrogen atoms per molecule.

These mobile hydrogen compounds are generally polymers containing two or more hydroxyl functions (alcohol or phenol) and/or thiol functions and/or primary or secondary amine functions and/or containing precursor functions, such as epoxy or carbonate functions which release hydroxyl functions by reacting with a suitable nucleophile (an amine or water for example).

The compounds are preferably selected from the polyols which may be used either alone or in a mixture.

The polyols used in the formulations of the invention are advantageously selected from acrylic or polyester or polyurethane or polyether polymers.

The polyester polyols are industrial products and the synthesis thereof is for the most part described and known to the person skilled in the art. The synthesis will therefore not be described in this document. For more details, please refer to the following publications: “Matériaux polymères, structure, propriétés et applications” by Gottfried W. Ehrenstein and Fabienne Montagne published in 2000 by Hermes Science; “Handbook of Polyurethanes” by Michael Szycher, published in 1999 by CRC press; “Resins for coatings, Chemistry, Properties and Applications” by D. Stoye and W. Freitag, published by Hanser in 1996, as well as the aforementioned Eurocoat 97 article. It is also possible to refer to the commercial catalogues of polyol distributors, in particular the book entitled “Specialty Resins, creating the solution together” from AKZO NOBEL RESINS published in February 2001.

The average functionality of hydroxyl functions in the polyol polymers is at least 2, generally between 3 and 20.

The definition of the average functionality of hydroxyl functions per polymer chain is given, for example, in the article by Ben Van Leeuwen entitled “High solids hydroxy acrylics and tightly controlled molecular weight” which appeared in the collected lectures from Eurocoat 1997 (pp 505-515) on page 507.

This average functionality F(OH) is calculated using the following equation:

$$F ( OH ) = \frac{( OH number ) \times Mn}{56 \times 100}$$

in which:
F(OH) represents the average functionality of hydroxyl functions;
OH number represents the hydroxyl function titre expressed in mg of KOH (potassium hydroxide) per gram of polymer;
Mn represents the number average molecular weight of the polymer, determined by gel permeation chromatography (GPC) by comparison with polystyrene calibration standards.

The number average molecular weight, of the polyester polyols used in the composition of the invention is generally between 500 and 10,000, preferably between 600 and 4,000.

In some cases it is also possible to use a polyacrylic polyol or a mixture of polyacrylic polyols which provide the coating with a greater degree of hardness. These polyols may be “hard” or “flexible” depending on whether monomers with an aromatic and/or cycloaliphatic and/or highly branched nature for the “hard” property and monomers having mostly an aliphatic nature for the “flexible” property are used respectively.

The synthesis of acrylic polyols is also known to the person skilled in the art and the aforementioned books may be consulted for more details on the synthesis of said acrylic polyols.

The number average molecular weight, for the acrylic polyols is generally between 134 and 50,000, preferably between 500 and 25,000, advantageously between 1,000 and 15,000.

The hydroxyl function titer is generally between 10 and 750 mg of KOH per gram of the polymer, preferably between 15 and 500 mg of KOH per gram of the polymer.

For examples of the acrylic polyols, please refer to the aforementioned Rhodocoat 97 article, page 515, where the characteristics of some acrylic polyols are listed, but the scope of the invention is not limited to these examples.

It is also possible to use hyperbranched polyols which are generally characterised by a higher functionality than linear polyols, but these products are not preferred due to the high viscosity thereof.

Structured polyols or block polyols may also be used if compartmentalisation of properties is desired. However, these products are generally more expensive and only used to provide one particular property. These compounds are, for example, a rheological agent or an agent which facilitates the dispersion of pigments.

As a general rule, for the purposes of the present invention, the amount of hardener relative to the resin is between 3% and 30% by weight, preferably between 5% and 20% by weight, advantageously between 5% and 15% by weight. However, for some applications, other ratios may be used, for example 1% by weight hardener relative to the resin, or even 400% by weight hardeners relative to the resin.

If the resin comprises mobile hydrogen functions, the ratio by weight (isocyanate functions of the hardener composition)/(mobile hydrogen functions) is generally between 2 and μ0.5, preferably between 1.5 and 0.8. In particular, if the mobile hydrogen compound is a polyol, the isocyanate functions/hydroxyl functions ratio is between 2 and 0.5, preferably 1.5 and 0.8.

The invention also relates to the process for preparing a “high-gloss” coating, as defined above, comprising at least one polyisocyanate-type hardener composition defined above, said polyisocyanate being hydrophilic and comprising at least one hydrophobic polyisocyanate having allophanate functions, said allophanate functions being present in an amount equal to or greater than 6 mol % relative to the number of moles of isocyanate monomers converted, for preparing said hydrophilic hardener composition.

The process comprises the steps of mixing the various components of the coating in accordance with conventional methods known in this field, and said mixing procedure may be achieved, for example, by using conventional mixers, such as mixers or grinding mixers depending on the viscosity of the different components and the type of coating desired. It should be understood, however, that mixing may be carried out just before the coating is applied, or the composition may be in the form of a ready-to-use formulation (monocomponent formulation, or a 1K formulation). However, bicomponent (2K) formulations are preferred.

It may also be advantageous to produce separate premixes of only two or three of the components of the coating formulation then to mix the two or three premixes (2K or 3K formulations) just before use.

In a variant, the surfactant or mixture of surfactants may also be incorporated directly into the coating composition or may be added with one of the other components of said coating, that is to say with the polyol, the pigment(s) if the coating is a paint, the additives or any other component of the final coating composition.

It is preferred for said surfactant to be incorporated into the polyisocyanate hardener. The person skilled in the art, a specialist in formulations, will be able to determine the method of introduction of the surfactant(s) so as to obtain the composition according to the invention in the form of a solution.

The present invention also relates to the substrates coated by the coating composition defined above. The substrate may be of any type, for example wood, glass, metal, cement, thermoplastic or thermosetting polymer (plastics material), optionally comprising fillers, for example reinforcing fillers, such as glass fibres, carbon fibres and other fibres for example. The substrate is generally a substrate for flooring and advantageously a wood substrate for flooring, for example parquet flooring.

The examples illustrating the invention are given in the experimental part below and do not limit this invention.

### Experimental Part

### Preparation of Hydrophilic Polyisocyanate Hardeners

### a) Preparation of Hydrophobic Polyisocyanates Having Allophanate Functions

Three polyisocyanate compositions containing variable amounts of allophanate functions were prepared in accordance with the following procedure:

300 g of hexamethylene diisocyanate (HDI) were placed in a 1 L reactor equipped with a mechanical stirrer in an inert atmosphere. The temperature was brought to 85° C. and a choline solution was gradually poured into the butanol. The final amount of choline added was 200 ppm. The reaction temperature was maintained at 85° C. and the reaction was left until the desired conversion rate (TT) was obtained. The reaction crude was then purified by successive distillations so as to obtain the lowest residual HDI concentration possible.

For each of the three compositions, the amount of butanol and the conversion rate are summarised in table (1):

TABLE (1)

| | Butanol | | | |
|---|---|---|---|---|
| Product | added⁽¹⁾ | Allophanate⁽²⁾ | Trimer⁽³⁾ | Final TT |
| Composition A | 4% | 13% | 36% | 52% |
| Composition B | 9.5% | 19% | 25% | 64% |
| Composition C | 15% | 24% | 20% | 70% |

⁽¹⁾amount of butanol added expressed in moles of butanol/total moles of HDI;
⁽²⁾amount of HDI allophanate measured by GPC (gel permeation chromatography).
⁽³⁾amount of isocyanurate-type true trimer measured by GPC.

The characteristics of the compositions are shown in table (2). As a comparative, Tolonate® HDT (hexamethylene diisocyanate trimer) sold by Rhodia, and Desmodur® N 3300 sold by Bayer were used, the characteristics of these compositions also being shown in the same table.

TABLE 2

| | Concentration | Viscosity | mol %/converted HDI | | |
|---|---|---|---|---|---|
| | (NCO) | (mPa · s) | allophanates | carbamates | % HDI |
| Composition A | 20.6% | 1998 | 8.2 | 0 | 0.28 |
| Composition B | 19.8% | 1428 | 14.7 | 0 | 1.7 |
| Composition C | 18.1% | 1310 | 22.2 | 0.7 | 0.44 |
| Tolonate ® HDT | 21.6% | 2400 | ~2 | 0.3 | 0.15 |
| Desmodur ® N 3300 | 21.8% | 2400 | ~5 | 0.2 | <0.2 |

### b) Preparation of Hydrophilic Polyisocyanates According to the Invention

A neutralised mixture of surfactants TA1 containing (in % by weight):
17.4% of N,N-dimethylcyclohexylamine (DMCHA; CAS no. 98-94-2); and
82.6% of polyoxyethylene tridecyl ether phosphate surfactant
   was prepared.

The mixture was homogenised for one night in a roller pot. The next day, 2.3 g of the neutralised mixture of surfactants defined above was added to 17.7 g of each of the compositions A, B, C and Tolonate® HDT.

Three hydrophilic polyisocyanate compositions were obtained respectively comprising allophanate patterns referenced as A_{H}, B_{H} and C_{H} and a reference composition HDT_{H} as a comparison.

### c) Preparation of a Varnish

A portion A 1 containing:
176 g of Setalux C6511 AQ 47 (acrylic emulsion sold by Akzo Nobel);
0.05 g of surface tension-reducing additive BYK 306;
1.5 g of Tinuvin® 292 (light stabiliser sold by CIBA™);
1 g of Solvesso® 100 (hydrocarbon-based solvent sold by ExxonMobil); and
20 g of demineralised water
   was prepared the day before preparing the varnish.

On the day of the test, 4 g of demineralised water (2 g for varnish B1) and 4.5 g of one of the hydrophilic polyisocyanate compositions comprising allophanate patterns, referenced as A_{H}, B_{H}, C_{H} and HDT_{H} and at 75% by weight in methoxypropyl acetate (AMP; CAS no. 108-65-6), were added to 10 g of portion A1.

Four varnish compositions were obtained respectively: Varnish A, Varnish B, Varnish B′, Varnish C, and a Varnish (HDT). The composition of each of the varnishes is summarised in table (3) below:

TABLE (3)

| | Portion | | Hydrophilic | Amount of |
|---|---|---|---|---|
| Varnish | A1 | Water | polyisocyanate | polyisocyanate |
| Varnish A | 10 g | 4 g | Composition A_{H} | 4.5 g at 75% in AMP |
| Varnish B | 10 g | 2 g | Composition B_{H} | 4.5 g at 75% in AMP |
| Varnish B′ | 10 g | 4 g | Composition B_{H} | 4.5 g at 75% in AMP |
| Varnish C | 10 g | 4 g | Composition C_{H} | 4.5 g at 75% in AMP |
| Varnish | 10 g | 4 g | Composition | 4.5 g at 75% in AMP |
| (HDT) | | | HDT_{H} | |

### Determining Haze on a Glass Plate

Each of the varnishes obtained was applied to a glass plate using an automatic film dispenser at a humid thickness of 200 μm. After a flash-off of 15 min, the glass plate was cured at 60° C. for 35 min. Haze was inspected after 7 days.

A haze of approximately 20 HU (“Haze Unit” measured using an Erichsen Microhaze 20° glossmeter) was obtained for each of the coatings obtained from varnish compositions A, B, B′ and C whilst the coating obtained from Varnish (HDT) had a haze of 48 HU.

The results are summarised in table (4):

TABLE (4)

| Varnish | Haze (HU) | Thickness (μm) |
|---|---|---|
| Varnish B | 22 | 43 |
| Varnish B′ | 22 | 43 |
| Varnish C | 20 | 42 |
| Varnish (HDT) | 48 | 44 |

### Determining Shine on a Glass Substrate (Varnish PUD)

### a) Preparation of Hydrophilic Polyisocyanates According to the Invention

The same hydrophobic polyisocyanates as described before were used. 17.7 g of each of the polyisocyanates were homogenised for one night in roller pots with 2.3 g of the neutralised mixture of surfactants TA 1.

8.57 g of dimethylether diethylene glycol (DMM; CAS no. 111109-77-4) were added to 20 g of the various compositions obtained so as to obtain solutions containing 70% of non-volatile matter.

### b) Preparation of the Varnish

Portion A2 was prepared the day before preparing the varnish in the following mariner: first of all:
3 g of anti-foaming agent BYK 028;
3 g of additive BYK 348, which improves wetting on the support; and
28 g of butylglycol acetate (BGA; CAS no. 112-07-2)
   were mixed.

6 g of the above mixture were then dispersed in 75 g of resin U 205 (aqueous dispersion of aliphatic polyether-polyurethane with no solvent and no free isocyanate group, anti-volatile matter: 40%, viscosity: 20-200 mPa·s, sold by Alberdingk & Boley) using a Dispermat disperser (500 rpm). 69 g of resin U205 were then added to the mixture so as to obtain 150 g of portion A2.

2 g of hardener mixtures (at 70% in DMM) were added to 20 g of portion A2. The varnishes Varnish A2, Varnish B2, Varnish C2 and Varnish (HDT)2 were obtained respectively. The mixture was homogenised with a spatula then applied to a glass plate using an automatic film dispenser for a humid thickness of 200 μm. A test was also carried out on a composition of portion A2 alone (without a hardener).

After drying in a conditioned room in a controlled atmosphere (23° C., relative humidity: 50%), the films were analysed on day +7 with regard to shine using an Erichsen glossmeter (Minigloss Master Model 540 or Microhaze 20°). The results are summarised in table (5):

TABLE 5

| | | Product | | | | |
|---|---|---|---|---|---|---|
| | | Varnish | Varnish | Varnish | Varnish | Portion A2 |
| | | A2 | B2 | C2 | (HDT)2 | alone |
| Thickness (μm) | | 40 | 38 | 31 | 31 | 39 |
| Shine | Haze | 85 | 148 | 69 | 272 | 24 |
| | 20° | 72 | 62 | 75 | 41 | 79 |
| | 60° | 86 | 82 | 87 | 71 | 89 |

A significant improvement in the shine of the coatings was observed. The shine of portion A2 alone was retrieved with hardener compositions comprising allophanate patterns whilst this shine significantly decreased when using Rhodia HDT compositions containing no allophanate functions.

### Determining Shine on a Glass Substrate and a Wood Substrate (Varnish PUD)

### a) Preparation of Hydrophilic Polyisocyanates According to the Invention

The hydrophobic polyisocyanates (with allophanate functions) defined above as Composition A, Composition C, Tolonate® HDT and Desmodur® N3300 were used.

The mixture of surfactants TA 1 described in example 1 was prepared.

After homogenisation for one night in a roller pot, 2.3 g of this neutralised mixture of surfactants was added to 17.7 g of each of the compositions A, C, Tolonate® HDT and Desmodur® N3300. The hardeners were formed of 88.5% of hydrophobic polyisocyanates and 11.5% of the mixture of surfactants.

8.57 g ethyl 3-ethoxyproprionate (EEP; CAS no. 763-69-9) were added to 20 g of the various compositions above so as to obtain solutions containing 70% anti-volatile matter (that is to say 30% solvent per 70% aqueous phase hardener).

Four hydrophilic polyisocyanate compositions comprising allophanate patterns referenced as A_{H3}, C_{H3}, HDT_{H3} and N3300_{H3} were obtained respectively.

### b) Preparation of a Varnish

Portion A3 was prepared the day before preparing the varnish from a first mixture of:
234.6 g of Alberdingk & Boley resin U 915 (polyurethane dispersion, anti-volatile matter: 33-35%, viscosity: 30-100 mPa·s);
46.8 g of water
6.6 g of Acrysol RM8; and
10.4 g of BDG (Butyl diglycol or [2-(2-butoxyethoxy)ethanol], CAS no. 112-34-5).

The mixture was mixed for 5 min in the Dispermat at 500 rpm.

The following were than added:
6.6 g of anti-foaming agent BYK 028;
1.2 g of additive BYK 348, which improves wetting on the support; and
270 g of resin U 915.

The mixture was again mixed for 5 min in the Dispermat at 500 rpm. Hardeners A_{H3}, C_{H3}, HDT_{H3} and N3300_{H3} prepared previously were added to said portion A3 at a ratio of 1 part hardener per 9 parts portion A3. Varnishes Varnish A3, Varnish C3, Varnish (HDT)₃ and Varnish (N3300) were obtained respectively. A test was also carried out on a composition of portion A3 alone (varnish without hardener).

### c) Determining Shine on Glass

The varnishes obtained above were applied using a film dispenser at a thickness of 200 μm on a glass plate. Shine was measured (haze, 60° and 20°) on day 7 using an Erichsen glossmeter as defined above. 2 g of the varnishes obtained above were also applied twice by brush to beechwood plates each measuring 10 cm by 15 cm. Shine was measured on day 7.

The results obtained are summarised in table (6):

TABLE 6

| | | Varnish | | | | |
|---|---|---|---|---|---|---|
| | | | | | | Varnish |
| | | | | | | without |
| | | Varnish_{A3} | Varnish_{C3} | Varnish_{HDT3} | Varnish_{N3300} | hardener |
| Portion A3 | | 10 g | 10 g | 10 g | 10 g | 10 g |
| Hydrophilic | type | A | C | HDT | N 3300 | — |
| hardener | amount | 1.1 g | 1.1 g | 1.1 g | 1.1 g | — |
| Water (amount in g) | | 4 | 4 | 4 | 4 | 4 |
| Shine | 60° | 91 | 94 | 77 | 77 | 92 |
| on glass | 20° | 81 | 87 | 48 | 48 | 85 |
| on day 8 | Haze | 31 | 25 | 270 | 250 | 27 |

Varnishes A3 and C3 have better properties with regard to shine than varnishes HDT3 and N 3300 on a glass plate.

It should be noted that a low level of shine was obtained using the Desmodur® N3300-based hardener which contains 5% allophanate patterns.

1.-16. (canceled)

17. An aqueous phase polyurethane coating formulation produced from a hydrophilic polyisocyanate hardener composition comprising at least one hydrophobic polyisocyanate containing one or more allophanate functions, said allophanate functions being present in said hardener composition in an amount at least equal to 6 mol % relative to the total number of moles of isocyanate monomers converted into said hardener composition.

18. The polyurethane coating formulation as defined by claim 17, wherein the amount of allophanate functions is less than or equal to 30 mol % relative to the total number of moles of isocyanate monomers converted into said hardener composition.

19. The polyurethane coating formulation as defined by claim 17, wherein the polyisocyanate is selected from among the homocondensation or heterocondensation products of an alkylene diisocyanate, comprising “biuret”-type and “trimer”-type products, or isocyanate function “prepolymers”, from the polyisocyanate derivatives resulting from aromatic isocyanates alone or mixed with aliphatic compounds, and from mixtures thereof.

20. The polyurethane coating formulation as defined by claim 17, wherein the allophanate functions are those of an allophanate of at least one polyisocyanate with at least one compound carrying a hydroxyl function.

21. The polyurethane coating formulation as defined by claim 17, wherein the allophanate functions are those of an allophanate selected from among hydrophobic polyisocyanate allophanates, optionally comprising one or more functions selected from among diazetidinedione, oxadiazinetrione, imino-dimer, imino-trimer (imino-triazinedione) imino-oxidiazinedione, isocyanurate, biuret, urea, urethane and mixtures thereof.

22. The polyurethane coating formulation as defined by claim 17, wherein the allophanate functions are those of an allophanate of hexamethylene diisocyanate isocyanurate and/or hexamethylene diisocyanate, isocyanurate, with a compound carrying a hydroxyl function.

23. The polyurethane coating formulation as defined by claim 17, wherein the hardener comprises an anionic and/or non-ionic surfactant, optionally comprising a polyethylene glycol and/or propylene glycol chain fragment having at least 1 ethylene oxyl and/or propylene oxyl units.

24. The polyurethane coating formulation as defined by claim 23, wherein less than 50% by weight of the surfactant is bound by a chemical bond to the polyisocyanate.

25. The polyurethane coating formulation as defined by claim 23, wherein the surfactant has the formula (I): 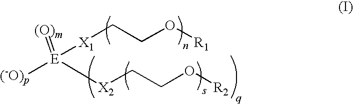
in which:
E is an element selected from among phosphorus, carbon and sulphur;
R₁ and R₂, which may be the same or different, are each a hydrocarbon radical;
X₁ is a bond or a divalent radical selected from among —Y₁—, -A₁-, -A₁-Y₁—, —Y₁-A₁-, —Y₁-A₁-Y′₁— and —[E(O)ₘ(O⁻)ₚ]—;
X₂ is a chemical bond or a divalent radical selected from among —Y₂—, -A₂-, -A₂-Y₂—, —Y₂-A₂- and —Y₂-A₂-Y′₂—;
A₁ and A₂, which may be the same or different, are each a divalent alkylene radical, optionally substituted, including a functionalized divalent alkylene radical;
Y₁, Y′₁, Y₂ and Y′₂, which may be the same or different, are each a chalcogen, the metalloid elements having atomic sizes at least equal to that of phosphorus and belonging to column VB of the Periodic Table, in the form of tertiary amine or phosphine derivatives;
m is zero or an integer equal to 1 or 2;
n is zero or an integer ranging from 1 to 30;
p is an integer equal to 1, 2 or 3;
g is zero or 1; and
s is zero or an integer ranging from 1 to 30;
with the proviso that when E is a carbon atom, then g is equal to zero, m is 1 and X₁ is a chemical bond or a divalent radical selected from among -A₁-, —Y₁—, -A₁-Y₁—, —O—C(═O)—O— and —[C(O)ₘ(O⁻)ₚ]—.

26. The polyurethane coating formulation as defined by claim 23, wherein the surfactant has structure (II₁) or structure (II₂): 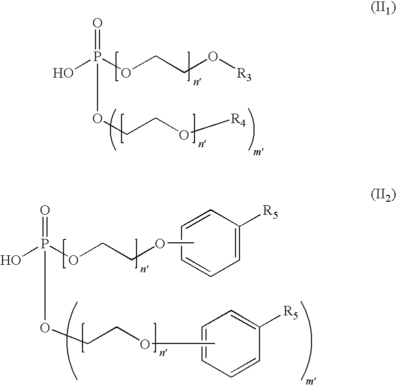
in which structures:
n′ is an integer ranging from 5 to 12;
m′ is 0 or 1;
R₃ and R₄, which may be the same or different, are each a linear or branched alkyl radical having from 10 to 20 carbon atoms; and
R₅ is a linear or branched alkyl radical having from 6 to 12 carbon atoms.

27. The polyurethane coating formulation as defined by claim 23, wherein the hardener comprises a non-ionic surfactant selected from among the derivatives of polyoxyalkylene fatty acid esters, ethoxylated alkylphenols, ester phosphates having a poly alkyloxy alkylene glycol chain and tristyrylphenols having an ethylene polyoxide chain.

28. The polyurethane coating formulation as defined by claim 23, wherein the amount of surfactant is less than 25% by weight relative to the polyisocyanate composition.

29. The polyurethane coating formulation as defined by claim 23, wherein the amount of surfactant is at least equal to 1% by weight relative to the weight of the polyisocyanate composition.

30. The polyurethane coating formulation as defined by claim 17, wherein the composition further comprises one or more pigments and/or additives selected from among rheological additives, leveling additives, surfactant additives and other additives, and mixtures thereof.

31. The polyurethane coating formulation as defined by claim 17, comprising a flooring coating.

32. The polyurethane coating formulation as defined by claim 17, deposited onto a wood, glass, metal, cement, thermoplastic or thermosetting polymer substrate.
